(19) United States
(12) Patent Application Publication
(10) Pub. No.: US 2006/0150324 A1
(43) Pub. Date: Jul. 13, 2006

(54) Portable infant auto changing table

(76) Inventors: Joesef Herman Jackson, Modesto, CA (US); Wilbur Willis Silva, Modesto, CA (US)

Correspondence Address: WILBUR W. SILVA, 1705 DUCKART WAY, MODESTO, CA, 95355, US

(21) Appl. No.: 11/031,871

(22) Filed: Jan. 10, 2005

(51) Int. Cl. B60P 3/38

(52) U.S. Cl. 5/118; 5/655

(57) ABSTRACT

A removable, adjustable, portable apparatus positioned on the rear surface of a front seat of an automobile, secured around the seat head rest, providing a surface when positioned to aupport an infant to change a diaper in an automobile.

### BACKGROUND OF THE INVENTION

1. Technical Field

This invention relates to a device to enable an adult to efficiently attend to an infant by providing a folding, rotatable, adjustable surface on which to place an infant to change the diaper of said infant in an automobile.

2. Description of Prior Art

A search of prior art revealed:

U.S. Pat. No. 4,876,970 sets forth a coin operated, wall mounted fold down child diaper changing table that is placed in public lavatories for parents with an infant, who are just out and about, or traveling.

U.S. Pat. No. 2,735,737 describes a diapering support comprising a wall mounted housing supporting a roll of disposable paper to be drawn downward from the housing. The housing itself contains a multi-hinged flat surface secured at one end and two folding arms on the other.

U.S. Pat. No. 2,817,571 sets forth a wall mounted folding table secured by means of a plurality of articulating arms and springs provided for locking said table in the down or extended position during non-use to be folded back against the support wall.

U.S. Pat. No. 4,613,996 sets forth a folding child support secured to a wall surface in a rectangular enclosure. The enclosure contains a plurality of compartments and shelves as well as utility features mounted therein. The enclosure includes a hingeably secured pivotable outer surface in the closed position and an extended position forming a child care surface.

Other practitioners have provided examples of folding table mechanisms included in: U.S. Pat. Nos. 2,815,700, 2,857,222, 3,232,663 and 3,689,344.

The foregoing examples provided various mechanisms for wall mounted infant care fold down tables and some during traveling, but none provided an in car folding, adjustable table, should the traveler not be near a public facility when needed.

### SUMMARY OF THE INVENTION

The object of this invention is to present an on board, in car, folding adjustable infant care station for the traveler to be utilized whether or not a public facility is available by merely pulling off the road and attending to the needs of the child without leaving the automobile.

### DESCRIPTION OF THE DRAWINGS

FIG. 1 depicts a right oblique view of the Portable Infant Auto Changing Table affixed to the rear surface of an automobile front seat in the folded, or travel position.

FIG. 2 shows a left side view of the front seat of an automobile with the Portable Infant Auto Changing Table components in the folded, or traveling position.

FIG. 3 illustrates another side view of the table of the invention in the folded position to accept an infant for care.

FIG. 4 shows a front view of the invention, while FIG. 5 reveals a side view of the component parts comprising all the adjustment mechanisms. All adjustment mechanisms are typical.

### DESCRIPTION OF THE PREFERRED EMBODIMENT

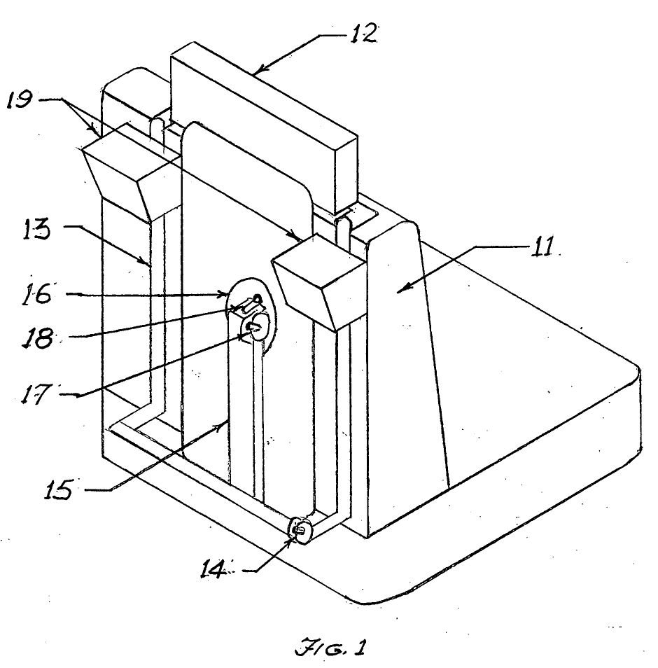

FIG. 1 sets forth a right oblique view of the front seat of an automobile affixed with the Portable Infant Auto Changing Table in the folded, or travel mode. The automobile seat 11 supports the head rest 12 with the Portable Infant Auto Changing Table frame 13 resting on the top of the back support 11 and forward of the head rest 12. The frame 13, extends vertically downward on each side of the seat back support 11, to the bottom of said seat back support and horizontally rearward to the vertical adjustment mechanism 14. The vertical adjustment mechanism 14 is adjustably affixed to the vertical support bar 15 and extends upward from the horizontal frame 13 to the center of the changing table 16. The changing table 16 is folded vertically against the rear surface of the back support portion of the seat 11, by activating both the table vertical adjustment mechanisms 14 and 17, located at each end of the vertical support bar 15. The utility trays 19 are affixed to the two descending portions of the frame 13. The Portable Infant Auto Changing Table can be affixed to the head rest 22 by simply holding said table components in the horizontal position above the head rest, lowering the frame 23 in front of the head rest 22 until coming to rest on the top portion of the seat support 21 and rotating the Portable Infant Changing Table downward until it comes to rest on the rear surface of the seat back support 21. To remove the Portable Infant Auto Changing Table, simply reverse the procedure.

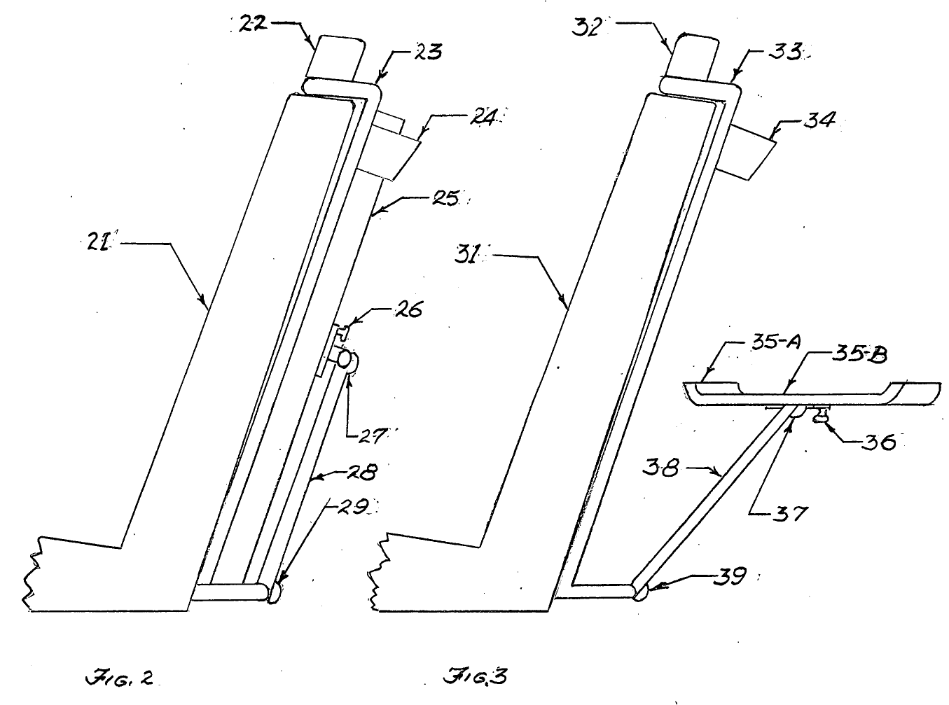

FIG. 2 shows a left view of the front seat 21, of an automobile and the head rest 22, with the frame 23 resting around the front bottom portion of the head rest 22, affixing it to the seat back support 21. The utility tray 24 is affixed to the descending portions of the frame 23. The table 25 is folded and resting on the rear surface of the back support portion of the seat 21. The vertical support bar 28 has two adjustment mechanisms 27 and 29, located at each end. The horizontal rotation control mechanism 26 allows the operator to adjust the table to the desired position when folding the table 25 for travel, or not in use.

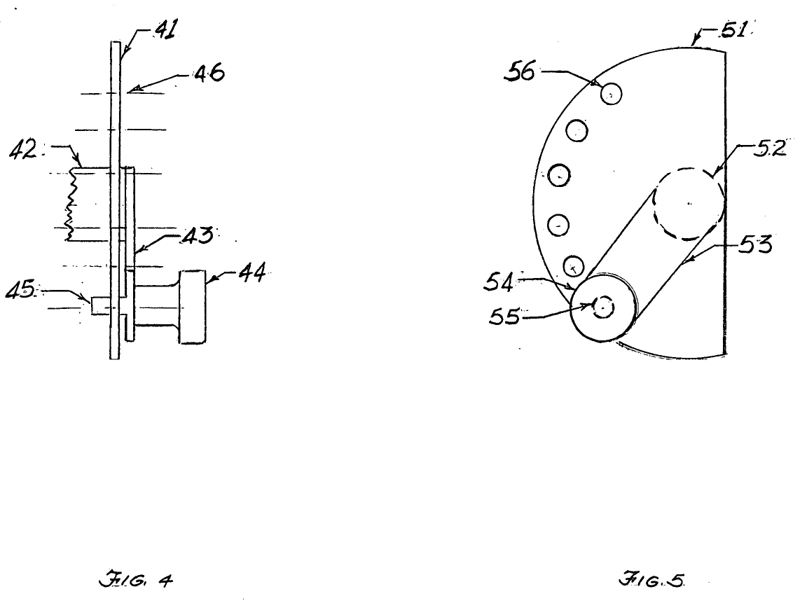

FIG. 3 depicts also the left view of the front seat of an automobile 31, head rest 32, supporting frame 33 and utility tray 34 with the Portable Infant Auto Changing Table 35-A in the horizontal position to receive an infant placed on the foam pad 35-B, rotated horizontally for convenience by activating the horizontal rotation mechanism 36. The desired position is attained by pulling the knob 36 downward far enough to clear the table for rotation and moving the table 35-A to that position. The table 35-A is supported by the vertical support bar 38, with vertical adjustment mechanisms 37 and 38 located at each end.

FIG. 4 shows a front view of the adjustment mechanisms. The fixed disc 41 is affixed to the frame portion 42 and contains a plurality of holes 46, strategically placed to accept the rotationally adjustable peg 45 attached to the pull knob 44 affixed to the spring bar 43 which is further attached to the rotational bar 42.

FIG. 5 describes a side view of the adjustment mechanism. 51 is the stationary disc containing a plurality of strategically spaced holes 56, so when the adjustment knob 54 is pulled, the adjustment peg 55 is dislodged from the adjustment hole 56 and can be rotated to the desired position. By releasing the knob 54, the locking peg 55 is forced into an adjustment hole 56 by the spring action of the spring bar 53, that is rotationally attached to the rotational bar 52.

1. A portable infant changing table for use in an automobile, comprising:
A frame affixed to the back of the front seat of a car and adjustable vertically along the seat back, the frame having a lower portion and a changing surface pivotably attached to the lower portion of the frame, said surface capable of folding against the back of the seat and locking into a horizontal position to support an infant.

2. The changing table as in claim 1, wherein the changing surface can be adjusted horizontally.

3. The changing table as in claim 1, wherein the changing surface has a soft pad to provide comfort to the infant.

4. The changing table as in claim 1, further comprising a connector pivotably attached to the bottom of the changing surface to allow easy adjustment of the surface.
